(19) United States
(12) Patent Application Publication
(10) Pub. No.: US 2020/0063785 A1
(43) Pub. Date: Feb. 27, 2020

(54) THREADING BOLT AND CORE STACKING TABLE, BUILDING PLATFORM, STACKING DEVICE OR THE LIKE COMPRISING AT LEAST ONE THREADING BOLT

(71) Applicant: HEINRICH GEORG GMBH MASCHINENFABRIK, Kreuztal (DE)

(72) Inventors: Jost Friedrich, Hilchenbach (DE); Volker Loth, Freudenberg (DE); Thomas Fünfsinn, Freudenberg (DE); Marc Grübener, Netphen (DE)

(21) Appl. No.: 16/549,164

(22) Filed: Aug. 23, 2019

(30) Foreign Application Priority Data
Aug. 23, 2018 (DE) 102018120557.0

(51) Int. Cl. F16B 39/284; F16B 5/02

(52) U.S. Cl. CPC F16B 39/284; F16B 5/025

(57) ABSTRACT

A threading bolt (1) for stacking sheets provided with at least one threading hole (2), in particular core sheets (3) of transformer cores, on a core stacking table (4), on a building platform, on a stacking device or the like, at least one threading bolt (1) being positionable on the core stacking table (4), on the building platform, on the stacking device or the like, wherein the outer diameter (Dₐ) of the threading bolt (1) is adaptable to different inner diameters (dᵢ) of the threading holes (2).

This application claims the benefit of German Patent Application No. DE 10 2018 120 557.0, filed Aug. 23, 2018, the disclosure of which is incorporated herein by reference.

### TECHNICAL FIELD

The invention relates to a threading bolt for stacking sheets provided with at least one threading hole, in particular core sheets of transformer cores, on a core stacking table, on a building platform, on a stacking device or the like, at least one threading bolt being positionable on the core stacking table, on the building platform, on the stacking device or the like. Furthermore, the invention relates to a core stacking table, a building platform or the like comprising at least one threading bolt.

### BACKGROUND

Transformer cores are typically composed of a plurality of core sheets. To produce transformer cores, the core sheets are continuously uncoiled from a supply coil, then cut to length and shape using a cutting system and potentially provided with at least one threading hole, and then stacked on the core stacking table, on the building platform or the like. An exact horizontal position of the individual core sheets relative to each other is essential for the quality of the finished transformer. The threading bolts positionable on the core stacking table, on the building platform or the like in connection with the threading hole or threading holes in the core sheets ensures that the dropped core sheets, which are carried by a supply device magnetically or by means of a vacuum, are precisely positioned on the core stacking table, on the building platform or the like.

Different architectures of transformers and different core designs require different diameters of the threading holes and different positions of the threading holes in the core sheets. The different diameters of the threading holes are typically in the range of 8 mm to 55 mm. Hence, when producing transformer cores, the threading bolts corresponding to the diameters of the threading holes have to be repositioned on the core stacking table, on the building platform or the like each time new core sheets are stacked, i.e. each time a new core is stacked.

The plurality of options regarding the diameters of the threading holes in the core sheet that depend on the core design results in a very large number of threading bolts of different diameters, all of which have to be held in stock.

### SUMMARY

The object of the invention is to provide a threading bolt of the above kind and a core stacking table, a building platform or the like that allow core sheets for different transformer cores to be stacked without having to replace the threading bolts because of varying threading hole diameters, whereby the number of different threading bolts having to be kept available is substantially reduced and the costs of producing transformer cores are consequently reduced, as well.

The outer diameter of the threading bolt according to the invention is adaptable to different inner diameters of the threading holes. By adapting the outer diameter of the threading bolt to the respective threading holes, different transformer cores having threading bolts that cover a certain range of diameters can be produced, whereby the number of threading bolts having to be held in stock is greatly reduced and costs can be saved. Furthermore, the adaption or an enlargement of the outer diameter of the threading bolt allows the core sheets to be pushed the rest of the way into the target position in the lower core sheet stacking area.

A reduction of the outer diameter of the threading bolt on the other hand allows the threading bolts to be removed once the core sheet stack is complete because friction between the threading bolts and the individual hole edges of the core sheets is precluded. Additionally, pulling out the threading bolts does not cause any damage to the hole edges in the case of a narrow variation of dimensions between the outer diameters of the threading bolts and the inner diameters of the threading holes; the same is true for the introduction of the threading bolts into the threading holes.

The threading bolt may have a base part which is detachably connectable to the core stacking table, to the building platform, to the stacking device or the like, a centering part which extends vertically above the base part, and a centering tip which is provided at the upper end of the threading bolt. By means of the base part, the threading bolt is positioned on the stacking table, on the building platform, on the stacking device or the like, the base part additionally being used for resting the core sheets or the core sheet stacks thereon. If the threading bolt is installed on the stacking device, the threading bolt is located above a building platform or above a core stacking table, wherein the threading bolt can dive into the threading holes of the core sheet stack from above so as to allow re-centering of the threading holes or of the core sheet stack. The centering part of the threading bolt ensures the exact position of the core sheets, the centering tip enabling greater placement tolerance for the core sheets to be placed above the threading bolt, which saves further cost because exact positioning of the core sheets is unnecessary.

At least one longitudinal portion which extends across a section of the centering part may be adjustable in the radial direction, which allows the outer diameter of the threading bolt to be adapted to the inner diameters of the threading holes in said section at least.

In a first embodiment of the threading bolt, the threading bolt can have a cavity at least in the longitudinal portion which extends across the section of the centering part, said cavity being fillable with a fluid medium via a connecting opening, which extends from the lower end of the threading bolt to the cavity, in order to change the outer diameter of the threading bolt. By introducing the fluid medium into the cavity and owing to the pressure acting on the relatively thin wall formed by the cavity, the cavity is inflated and the surrounding wall is adjusted or molded to the inner diameters of the threading bolts.

The wall of the threading bolt may be elastic in the longitudinal portion which extends across the section of the centering part, i.e. in the area of the cavity. The elasticity allows the cavity to be inflated relatively easily at little pressure and the surrounding wall to be easily deformed or molded to the surrounding wall.

The longitudinal portion of the threading bolt that extends across the section of the centering part may be formed by individual longitudinal segments, wherein a rubber-like balloon whose opening may be connected to the fluid medium may be insertable into the cavity. The balloon forms the elastic part of the cavity, the longitudinal segments protecting the balloon during stacking of the core sheets.

In a second embodiment of the threading bolt, the centering part of the threading bolt may be composed of a guiding part disposed on the base part and at least two centering segments mounted in the guiding part and guided for adjustment in the radial direction, wherein the centering segments may be horizontally adjustable together by means of a fluid medium or by mechanical force in order to change the outer diameter of the threading bolt.

In a third embodiment, the centering part of the threading bolt may be composed of at least two centering segments mounted in the base part and guided for adjustment in the radial direction, wherein the centering segments may be horizontally adjustable together by means of a fluid medium or by mechanical force in order to change the outer diameter of the threading bolt.

In these two embodiments, the pressure of the fluid medium or the mechanical force make the centering part or the centering segments easy to adapt or mold to the inner diameters of the threading bolts.

Guiding elements for the centering segments that allow easy radial adjustment of the centering segments may be provided in the guiding part, i.e. in the base part.

Preferably, radial center lines of the centering elements may be disposed at an angle of 120° relative to each other, whereby an exact centric position of the threading holes and an exact position of the core sheets are ensured at all times.

The fluid medium may be either gaseous or liquid.

The mechanical force may act on the centering segments via longitudinally adjustable wedge-shaped elements, for example, wherein the wedge-shaped elements may be rotationally or linearly driven and adjusted.

Alternatively, the mechanical force may act on the centering segments via articulated systems, wherein the articulated systems may be rotationally or linearly driven. The articulated systems may be composed of multiple members.

To limit the maximum adjustability of the centering segments, stops that prevent adjustment of the centering segments beyond the maximum possible outer diameter of the threading bolt or of the centering part of the threading bolt and that prevent the centering segments from slipping out of the guiding elements may be provided.

The centering segments may be restored into their inner default position by spring action, which ensures that the placed core sheets do not rest on the upper end of the threading bolts and, in particular, that the centering segments are in their inner default position so that the core sheets can be pushed the rest of the way into their target position.

The centering segments may have sheet rests that are integrally formed on them and that ensure clean placement of the core sheets or of the core sheet stack.

The core stacking table according to the invention, the building platform according to the invention, the stacking device according to the invention or the like is equipped with a threading bolt according to the disclosure.

### BRIEF DESCRIPTION OF THE DRAWING FIGURES

Hereinafter, embodiments of the threading bolt and of the core stacking table, of the building platform, of the stacking device or the like are explained in more detail by way of the schematic drawings.

FIG. 1 is a top view of a core sheet having two threading holes,

FIG. 2 is an illustration of the true-to-position stacking of cut core sheets using threading bolts according to the state of the art,

FIG. 3 is an enlarged section III of FIG. 2,

FIG. 4 is a section view of a first embodiment of the threading bolt according to the invention, the threading bolt being shown in its default position in the right half and the threading bolt adapted to the threading hole being shown in the left half,

FIG. 5 is a cut top view of a second embodiment of the threading bolt according to the invention, a centering segment being shown in its default position and another centering segment being shown in contact with the inner diameter of the threading hole of the core sheet or core sheet stack,

FIG. 6 is a cut according to line VI-VI in FIG. 5, and

FIG. 7 is a cut top view of a third embodiment of the threading bolt according to the invention, a centering segment being shown in its default position and another centering segment being shown in contact with the inner diameter of the threading hole of the core sheet or core sheet stack.

In the drawings, identical or corresponding elements are provided with identical reference signs.

### DETAILED DESCRIPTION

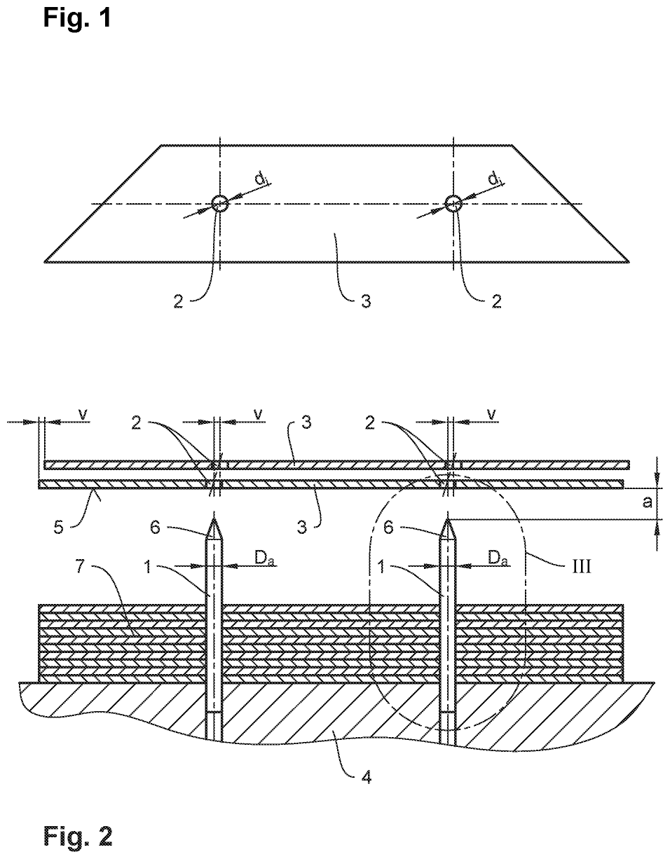

The threading bolts 1 illustrated in FIGS. 2 to 7 are provided for the precise stacking of sheets provided with threading holes 2, in particular core sheets 3 (cf. FIG. 1, in particular) of transformer cores (not shown), on a core stacking table 4, on a building platform, on a pallet or the like (hereinafter only referred to as a core stacking table for the sake of simplicity). Core sheets 3 are continuously uncoiled from a supply coil, then cut to length and shape using a cutting system and then provided with threading holes 2, then fed to core stacking table 4 using a feeding device, which carries core sheets 3 magnetically or by means of vacuum, dropped, and stacked on core stacking table 4.

By way of example, FIG. 1 shows a shape of a core sheet 3, wherein the shape, the length, and the position of threading holes 2 in core sheet 3 are to be adapted to the requirements of the transformer cores.

FIG. 2 shows a true-to-position stacking of core sheets 3 according to the state of the art. Threading bolts 1 having an outer diameter Dₐ that is slightly smaller than inner diameters dᵢ of threading holes 2 are positioned on or in core stacking table 4. Core sheet 3 fed by means of the feeding device is dropped at a distance a between bottom side 5 of core sheet 3 and a centering tip 6 of threading bolts 1 and is stacked into a core sheet stack 7 on core stacking table 4. Truncated centering tip 6 centers threading holes 2—and thus core sheets 3—during dropping even if core sheets 3 are dropped at a slight lateral offset v from one another. To avoid damage to core sheets 3 during dropping, truncated centering tip 6 is preferably rounded.

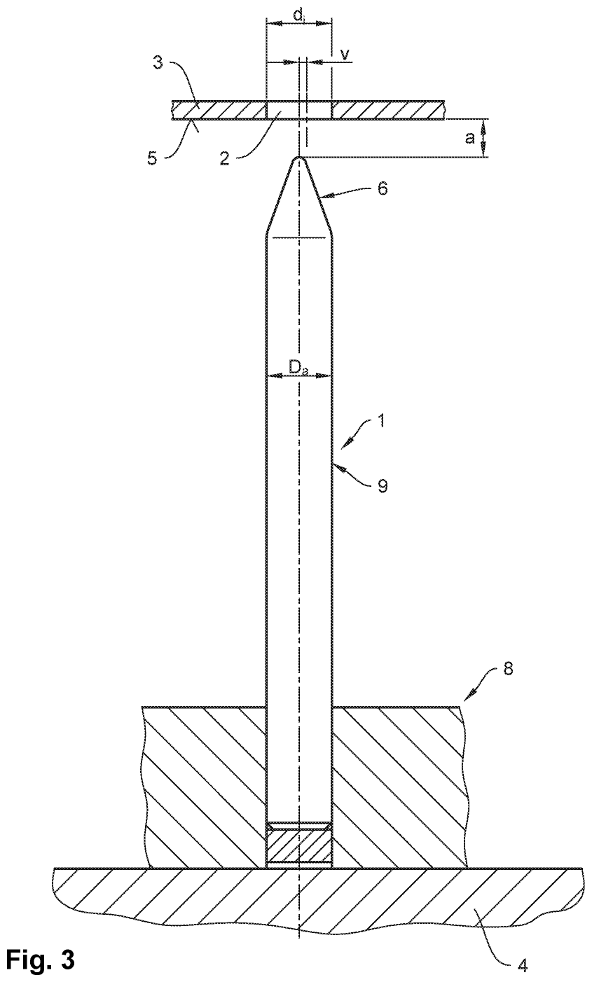

Each threading bolt 1 has a base part 8 detachably connectable to core stacking table 4, a centering part 9 vertically extending above base part 8 and serving to receive core sheets 3, and centering tip 6 provided at the upper end of threading bolt 1 (cf. FIGS. 3, 4, 6 and 7, in particular).

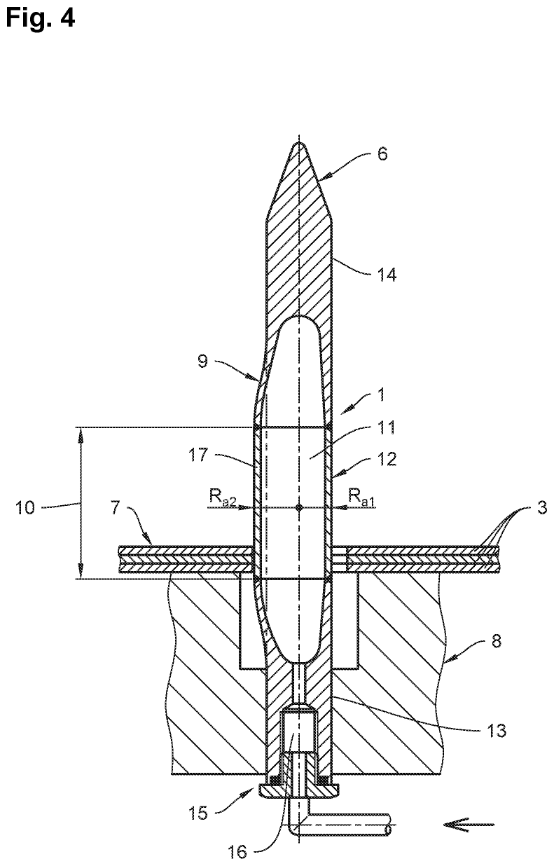

FIGS. 4 to 7 each show threading bolt 1, whose outer diameter Dₐ is adaptable to different inner diameters dᵢ, at least one longitudinal portion 10 which extends across a section of centering part 9 being adjustable in the radial direction.

In a first embodiment of threading bolt 1 (FIG. 4), threading bolt 1 has a cavity at least in portion 10 extending across the section of the centering part. Said cavity 11 may be formed by a tube portion 12 having a radius Rₐ₁ (cf. right half in FIG. 4), a bearing portion 13 which extends into the base part being adjacent to one end of tube portion 12 and a guiding part 14 which has centering tip 6 being adjacent to the other end. Cavity 11 can be filled with a fluid medium, which may be gaseous or liquid, via a connecting bore 16 extending from lower end 15 of threading bolt 1 to cavity 11, the pressure arising within cavity 11 pushing wall 17 of tube portion 12 outward and outer diameter Dₐ being adjusted to inner diameter dᵢ, whereupon tube portion 12 has a radius Rₐ₂ (=Dₐ/2) (cf. left half in FIG. 4).

In order to be able to keep the pressure on tube portion 12 relatively low, wall 17 of tube portion 12 is preferably elastic. Tube portion 12 may be composed of segments (not shown), a rubber-like balloon, whose opening can be connected to the fluid medium (not shown) via connecting bore 16, being disposed in tube portion 12, i.e. in cavity 11.

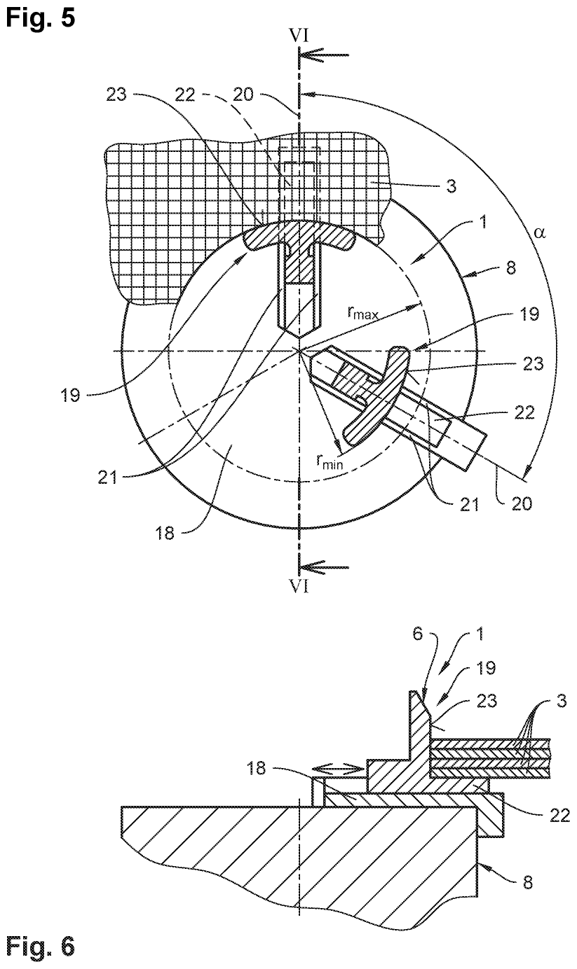

In second and third embodiments of threading bolt 1 (FIGS. 5 to 7), centering part 9 of threading bolt 1 is composed of a guiding part 18 disposed on base part 8 and of at least two centering segments 19 mounted in guiding part 18 and guided for adjustment in the radial direction, center lines 20 of centering segments 19 being disposed at an angle α of 120° relative to each other. Alternatively to being mounted in separate guiding part 18, centering segments 19 may also be mounted directly in base part 8. To be able to adapt outer diameter Dₐ of threading bolt 1 to inner diameter dᵢ of threading holes 2, centering segments 19 may also be horizontally adjustable by means of a fluid medium (gaseous or liquid) or by mechanical force (not shown).

For centering segments 19 to be precisely guided and easily adjusted, guiding elements 21 for centering segments 19 may be provided in guiding part 18, i.e. in base part 8.

The mechanical force may act on centering segments 19 either via longitudinally adjustable wedge-shaped elements or via articulated systems, for example, which are rotationally or linearly driven and adjusted, wherein the articulated systems may be composed of multiple members (not shown).

Stops may be provided to limit the maximum adjustability of centering segments 19 and to prevent centering segments 19 from slipping out of the guides or guiding elements 21, wherein centering segments 19 may be restored into their inner default position by spring action (not shown).

For a clean placement of core sheets 3, sheet rests 22 may be integrally formed on centering segments 19.

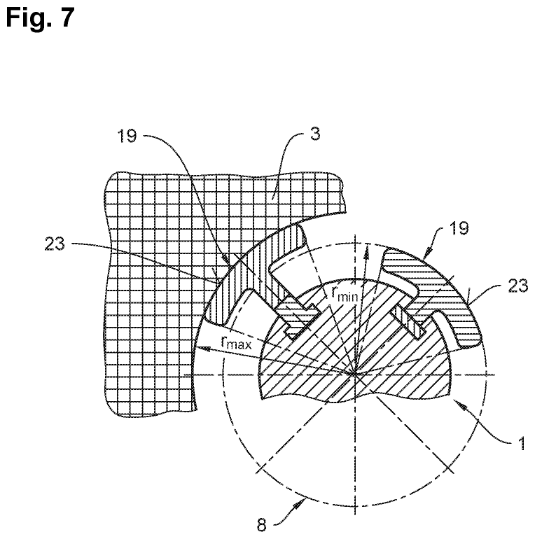

As mentioned, FIGS. 5 and 7 show threading bolts 1 according to the second and third embodiments in a top view, one centering segment 19 being in its default position and another centering segment 19 being in contact with inner diameter dᵢ of threading hole 2 of core sheet 3 or core sheet stack 7. Since threading bolts 1 cover a certain diameter range, the default position of centering segments 19, in which their circle segment-shaped contact surfaces 23 form a radius rₘᵢₙ, may correspond to the smallest inner diameter dᵢ of threading holes 2 of the diameter range, and the illustrated extended position of the centering segments 19, in which their circle segment-shaped contact surfaces 23 form a radius rₘₐₓ, may correspond to the largest inner diameter dᵢ of threading holes 2 of the diameter range.

1. A threading bolt (1) for stacking sheets provided with at least one threading hole (2), in particular core sheets (3) of transformer cores, on a core stacking table (4), on a building platform, on a stacking device, at least one threading bolt (1) being positionable on the core stacking table (4), on the building platform, on the stacking device wherein the outer diameter (Dₐ) of the threading bolt (1) is adaptable to different inner diameters (dᵢ) of the threading holes (2).

2. The threading bolt according to claim 1, wherein
the threading bolt (1) has a base part (8) which is detachably connectable to the core stacking table (4), to the building platform or the like, a centering part (9) which extends vertically above the base part (8), and a centering tip (6) which is provided at the upper end of the threading bolt (1).

3. The threading bolt according to claim 1, wherein
at least one longitudinal portion (10) which extends across a section of the centering part (9) is adjustable in the radial direction.

4. The threading bolt according to claim 1, wherein
the threading bolt (1) has a cavity (11) at least in the longitudinal portion (10) that extends across a section of the centering part (9), said cavity (11) being fillable with a fluid medium via a connecting bore (16), which extends from the lower end (15) of the threading bolt (1) to the cavity (11), in order to change the outer diameter (Dₐ) of the threading bolt (1).

5. The threading bolt according to claim 1, wherein
the wall (17) of the threading bolt (1) is elastic in the longitudinal portion (10) that extends across a section of the centering part.

6. The threading bolt according to claim 1, wherein
the longitudinal portion (10) that extends across a section of the centering part of the threading bolt (1) is composed of individual longitudinal segments, a rubber-like balloon whose opening is connectable to the fluid medium via the connecting bore (16) being insertable into the cavity (11).

7. The threading bolt according to claim 1, wherein
the centering part (9) of the threading bolt (1) comprises a guiding part (18) disposed on the base part (8) and of at least two centering segments (19) which are mounted in the guiding part (18) and guided for adjustment in the radial direction, the centering segments (19) being horizontally adjustable together by a fluid medium or by mechanical force in order to change the outer diameter (Dₐ) of the threading bolt (1).

8. The threading bolt according to claim 1, wherein
the centering part (9) of the threading bolt (1) comprises at least two centering segments (19) which are mounted in the base part (8) and guided for adjustment in the radial direction, the centering segments (19) being horizontally adjustable together by means of a fluid medium or by mechanical force in order to change the outer diameter (Dₐ) of the threading bolt (1).

9. The threading bolt according to claim 13, wherein
guiding elements (21) for the centering segments (19) are provided in the guiding part (18).

10. The threading bolt according to claim 7, wherein
radial center lines (20) of the centering elements (19) are disposed at an angle (α) of 120° relative to each other.

11. The threading bolt according to claim 4, wherein
the fluid medium is gaseous or liquid.

12. The threading bolt according to claim 7, wherein
the mechanical force acts on the centering segments (19) via longitudinally adjustable wedge-shaped elements, the wedge-shaped elements being rotationally or linearly driven and adjusted.

13. The threading bolt according to claim 7, wherein
the mechanical force acts on the centering segments (19) via articulated systems, the articulated systems being rotationally or linearly driven.

14. The threading bolt according to claim 13, wherein
the articulated systems comprise multiple members.

15. The threading bolt according to claim 14, wherein
stops are provided for limiting the maximum adjustability of the centering segments (19).

16. The threading bolt according to claim 7, wherein
the centering segments (19) are restored to their inner default position by spring action.

17. The threading bolt according to claim 4, wherein
the centering segments (19) have sheet rests (22) integrally formed on them.
